(19) United States
(12) Patent Application Publication
(10) Pub. No.: US 2015/0022948 A1
(43) Pub. Date: Jan. 22, 2015

(54) CAPACITOR STRUCTURE

(71) Applicant: Samsung Electronics Co., Ltd., Suwon-Si (KR)

(72) Inventors: Hyo-Joon AN, Anyang-si (KR); Youngjin CHO, Seoul (KR); Youn-Ho HWANG, Hwaseong-si (KR)

(21) Appl. No.: 14/319,259

(22) Filed: Jun. 30, 2014

(30) Foreign Application Priority Data
Jul. 19, 2013 (KR) 10-2013-0085254

(51) Int. Cl. H01G 4/005

(52) U.S. Cl. CPC H01G 4/005
USPC 361/303

(57) ABSTRACT

A capacitor structure includes a first electrode structure and a second electrode structure. The first electrode structure includes a first negative plate and a first positive plate spaced apart from each other. The first electrode structure has a first horizontal capacitance between the first negative plate and the first positive plate. The second electrode structure includes a second positive plate and a second negative plate spaced apart from each other on the first electrode structure. The second electrode structure has a second horizontal capacitance between the second negative plate and the second positive plate. First and second vertical capacitances are formed between the first negative plate and the second positive plate and between the first positive plate and the second negative plate.

### CROSS-REFERENCE TO RELATED APPLICATION

This application claims priority under 35 USC §119 to Korean Patent Application No. 10-2013-0085254 filed on Jul. 19, 2013 in the Korean Intellectual Property Office (KIPO), the entire disclosure of which is incorporated herein by reference.

### BACKGROUND

1. Field

Example embodiments relate to a capacitor structure. More particularly, example embodiments relate to a vertical native capacitor structure.

2. Description of the Related Art

As semiconductor devices have been highly integrated, a capacitor structure having a relatively high capacitance is needed in a relatively narrow horizontal region. For example, amplification devices included in a source driver of a display driver integrated circuit may require a capacitor structure having a relatively high capacitance.

### SUMMARY

Example embodiments provide a capacitor structure having a relatively high capacitance.

According to example embodiments, a capacitor structure includes a first electrode structure including a first negative plate and a first positive plate spaced apart from each other, the first negative plate and the first positive plate being arranged alternately and repeatedly in a first direction substantially parallel to a top surface of a substrate, and the first electrode structure having a first horizontal capacitance between the first negative plate and the first positive plate, and a second electrode structure on the first electrode structure, the second electrode structure including a second positive plate and a second negative plate spaced apart from each other, the second negative plate and the second positive plate being arranged alternately and repeatedly in the first direction, and the second electrode structure having a second horizontal capacitance between the second negative plate and the second positive plate, wherein at least a portion of the second negative plate overlaps at least a portion of the first positive plate in a third direction substantially perpendicular to the top surface of the substrate and at least a portion of the second positive plate overlaps at least a portion of the first negative plate in the third direction, and wherein first and second vertical capacitances are formed between the first negative plate and the second positive plate and between the first positive plate and the second negative plate, respectively.

In example embodiments, a dielectric layer may be between each of the first negative plate, the first positive plate, the second negative plate and the second positive plate in both the first and third directions, wherein the second negative plate and the first positive plate, and the first negative plate and the second positive plate facing each other in the third direction are insulated from each other by the respective dielectric layer. In example embodiments, the first and second negative plates may be electrically connected to each other, and the first and second positive plates may be electrically connected to each other.

In example embodiments, each of the first negative plate, the first positive plate, the second negative plate and the second positive plate include a first end and a second end opposite to the first end, and the capacitor structure may further include a first negative connection pattern electrically connecting the first ends of the first negative plates, a first positive connection pattern electrically connecting the second ends of the first positive plates, a second negative connection pattern electrically connecting the first ends of the second negative plates, a second positive connection pattern electrically connecting the second ends of the second positive plates, first via contacts electrically connecting the first and second negative connection patterns to each other in the third direction, and second via contacts electrically connecting the first and second positive connection patterns to each other in the third direction.

In example embodiments, the first and second ends of the first positive plate and the first and second ends of the second negative plate may not be aligned with each other in the third direction, and the first and second ends of the first negative plate and the first and second ends of the second positive plate may not be aligned with each other in the third direction. In example embodiments, each of the first negative plate, the first positive plate, the second negative plate and the second positive plate may extend in a second direction substantially perpendicular to the first direction, and each of the first negative plate, the first positive plate, the second negative plate and the second positive plate may be substantially parallel to each other.

In example embodiments, sidewalls of the second positive plate and sidewalls of the first negative plate may be aligned with each other in the third direction, and sidewalls of the second negative plate and sidewalls of the first positive plate may be aligned with each other in the third direction.

In example embodiments, first polysilicon patterns may be between the substrate and the first electrode structure, wherein a third horizontal capacitance may be formed between the polysilicon patterns, a third vertical capacitance may be formed between each of the first polysilicon patterns and the substrate, and a fourth vertical capacitance may be formed between each of the first polysilicon patterns and the first electrode structure.

In example embodiments, each of the first polysilicon patterns may be electrically connected to one of the first positive plate and the first negative plate. In example embodiments, the capacitor structure may include active regions spaced apart from each other at upper portions of the substrate, wherein a fourth horizontal capacitance may be formed between the active regions. In example embodiments, each of the active regions may be electrically connected to one of the first positive plate and the first negative plate included in the first electrode structure.

In example embodiments, the capacitor structure may include active regions spaced apart from each other on a substrate, the active regions forming a third horizontal capacitance, and polysilicon patterns provided between the active regions of the substrate and the first electrode structure, the polysilicon patterns forming a fourth vertical capacitance. In example embodiments, the capacitor structure may further include a third electrode structure and a fourth electrode structure sequentially stacked on the second electrode structure in the third direction, wherein the third electrode structure may have substantially the same structure as that of the first electrode structure, and the fourth electrode structure may have substantially the same structure as that of the second electrode structure. In example embodiments, the first and second electrode structures may include a metal.

According to example embodiments, a capacitor structure includes a first finger electrode on a substrate, the first finger electrode including a first negative connection pattern and first negative plates, the first negative connection pattern extending in a first direction substantially parallel to a top surface of the substrate and the first negative plates, and each of the first negative plates extending from the first negative connection pattern in a second direction substantially perpendicular to the first direction, a second finger electrode on the substrate, the second finger electrode including a first positive connection pattern and first positive plates, the first positive connection pattern extending in the first direction, and each of the first positive plates extending from the first positive connection pattern in the second direction and being inserted into a gap between the first negative plates, a third finger electrode over the first and second finger electrodes, the third finger electrode including a second negative connection pattern and second negative plates, the second negative connection pattern extending in the first direction, and each of the second negative plates extending from the second negative connection pattern in the second direction and overlapping at least a portion of each first positive plate in a third direction substantially perpendicular to the top surface of the substrate, and a fourth finger electrode over the first and second finger electrodes, the fourth finger electrode including a second positive connection pattern and second positive plates, the second positive connection pattern extending in the first direction, and each of the second positive plates extending from the second positive connection pattern in the second direction and overlapping at least a portion of each first negative plate in the third direction.

In example embodiments, the first and second negative connection patterns may face each other in the third direction, and the first and second positive connection patterns may face each other in the third direction. In example embodiments, the capacitor structure may further include first via contacts contacting the first and second negative connection patterns, and second via contacts contacting the first and second positive connection patterns. In example embodiments, the capacitor structure may further include a dielectric layer between the first negative plates included in the first finger electrode, the first positive plates included in the second finger electrode, the second negative plates included in the third finger electrode, and the second positive plates included in the fourth finger electrode, respectively.

In example embodiments, both ends of the first positive plates and both ends of the second negative plates may not be aligned with each other in the third direction, and both ends of the first negative plates and both ends of the second positive plates may not be aligned with each other in the third direction. In example embodiments, sidewalls of the second positive plates and sidewalls of the first negative plates may be aligned with each other in the third direction, and sidewalls of the second negative plates and sidewalls of the first positive plates may be aligned with each other in the third direction.

In example embodiments, the capacitor structure may further include first polysilicon patterns between the substrate and the first finger electrode, wherein a first horizontal capacitance may be formed between the first polysilicon patterns, a first vertical capacitance may be formed between each of the first polysilicon patterns and the substrate, and a second vertical capacitance may be formed between each of the first polysilicon patterns and the first finger electrode. In example embodiments, the first and second negative connection patterns may face each other in the third direction, and the first and second positive connection patterns may face each other in the third direction.

In example embodiments, the capacitor structure may further include active regions spaced apart from each other at upper portions of the substrate, the active regions having a second horizontal capacitance being formed therebetween, and polysilicon patterns between the active regions of the substrate and the first finger electrode, each of the polysilicon patterns having a second vertical capacitance being formed therebetween and between the first finger electrode.

In example embodiments, the capacitor structure may further include fifth and sixth finger electrodes on the third and fourth finger electrodes, respectively, the fifth and sixth finger electrodes having substantially the same structures as those of the first and second finger electrodes, respectively, seventh and eighth finger electrodes on the fifth and sixth finger electrodes, respectively, the seventh and eighth finger electrodes having substantially the same structures as those of the third and fourth finger electrodes, respectively, and via contacts electrically connecting the first, second, third, fourth, fifth, sixth, seventh and eighth finger electrodes to each other to which a signal of the same polarity is supplied, each of the via contacts extending in the third direction.

The capacitor structure in accordance with example embodiments may have the horizontal capacitance between conductive patterns spaced horizontally apart from each other and the vertical capacitance between conductive patterns spaced vertically apart from each other. Without a horizontal area increase, a vertical height increase or a stacked number of plates, the capacitance of the capacitor structure may increase.

### BRIEF DESCRIPTION OF THE DRAWINGS

Example embodiments will be more clearly understood from the following detailed description taken in conjunction with the accompanying drawings. FIGS. 1 to 14 represent non-limiting, example embodiments as described herein.

FIG. 1 is a plan view illustrating a capacitor structure in accordance with example embodiments.

FIG. 2A is a plan view of a first electrode structure in the capacitor structure in FIG. 1.

FIG. 2B is a plan view of a second electrode structure in the capacitor structure in FIG. 1.

FIG. 3A is a first cross-sectional view of a semiconductor device which includes the capacitor structure in FIG. 1.

FIG. 3B is a second cross-sectional view of a semiconductor device which includes the capacitor structure in FIG. 1.

FIG. 4 is a perspective view illustrating plates in the capacitor structure in FIG. 1.

FIGS. 5A and 5B are cross-sectional views of a semiconductor device which includes a capacitor structure in accordance with example embodiments.

FIGS. 6A and 6B are cross-sectional views of a semiconductor device which includes a capacitor structure in accordance with example embodiments.

FIGS. 7A and 7B are cross-sectional views of a semiconductor device which includes a capacitor structure in accordance with example embodiments.

FIGS. 8A and 8B are cross-sectional views of a semiconductor device which includes a capacitor structure in accordance with example embodiments.

FIGS. 9A and 9B are cross-sectional views of a semiconductor device which includes a capacitor structure in accordance with example embodiments.

FIGS. 10A and 10B are cross-sectional views of a semiconductor device which includes a capacitor structure in accordance with example embodiments.

FIG. 11 is a plan view illustrating a semiconductor device which includes a capacitor structure in accordance with example embodiments.

FIG. 12A is a plan view of a first electrode structure in the capacitor structure in FIG. 11.

FIG. 12B is a plan view of a second electrode structure in the capacitor structure in FIG. 11.

FIG. 13 is a cross-sectional view of a semiconductor device which includes the capacitor structure of FIG. 11.

FIG. 14 is a plan view illustrating a mobile display device which includes a capacitor structure in accordance with example embodiments.

### DETAILED DESCRIPTION

Various example embodiments will be described more fully hereinafter with reference to the accompanying drawings, in which some example embodiments are shown. The present inventive concept may, however, be embodied in many different forms and should not be construed as limited to the example embodiments set forth herein. Rather, these example embodiments are provided so that this description will be thorough and complete, and will fully convey the scope of the present inventive concept to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. The regions illustrated in the figures are schematic in nature and their shapes are not intended to illustrate the actual shape of a region of a device and are not intended to limit the scope of the present inventive concept.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

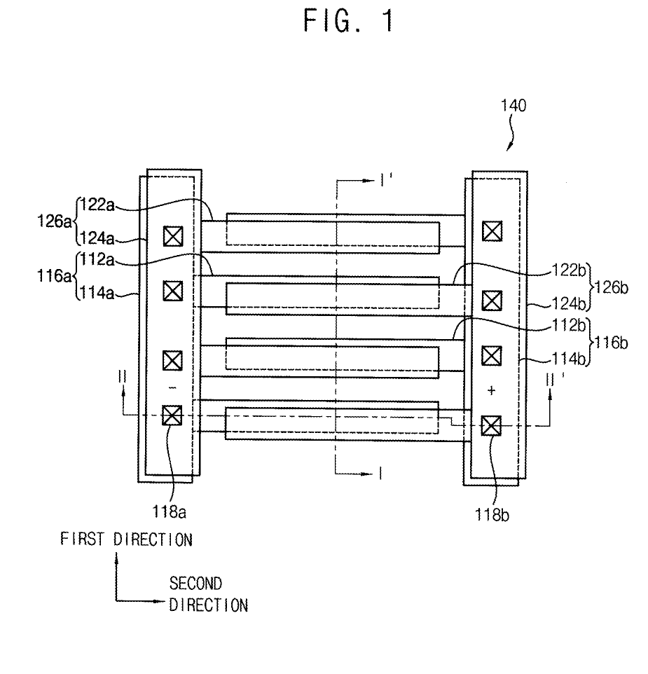

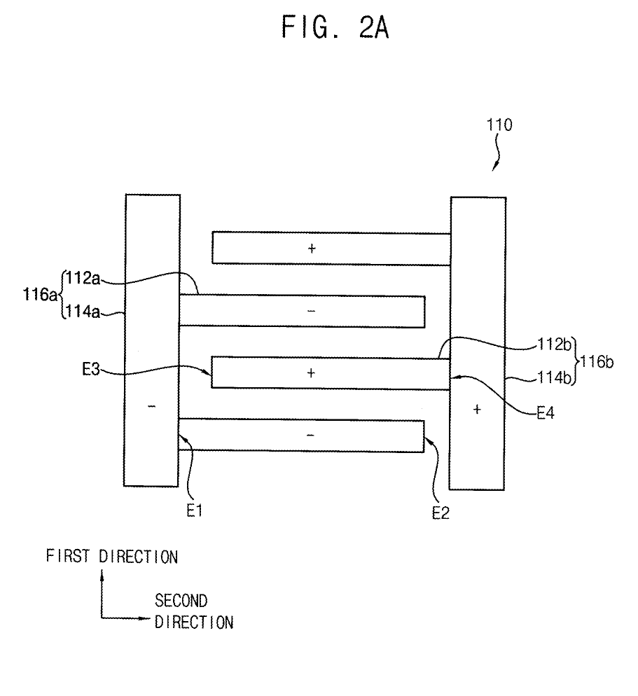

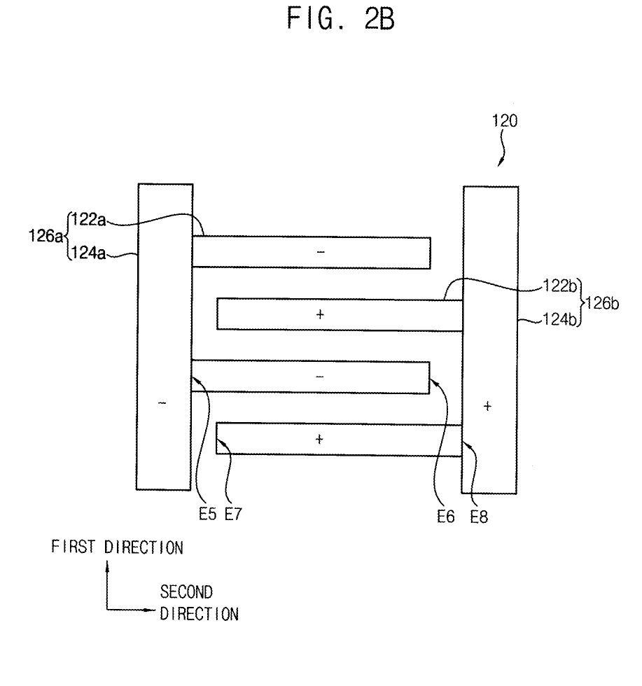

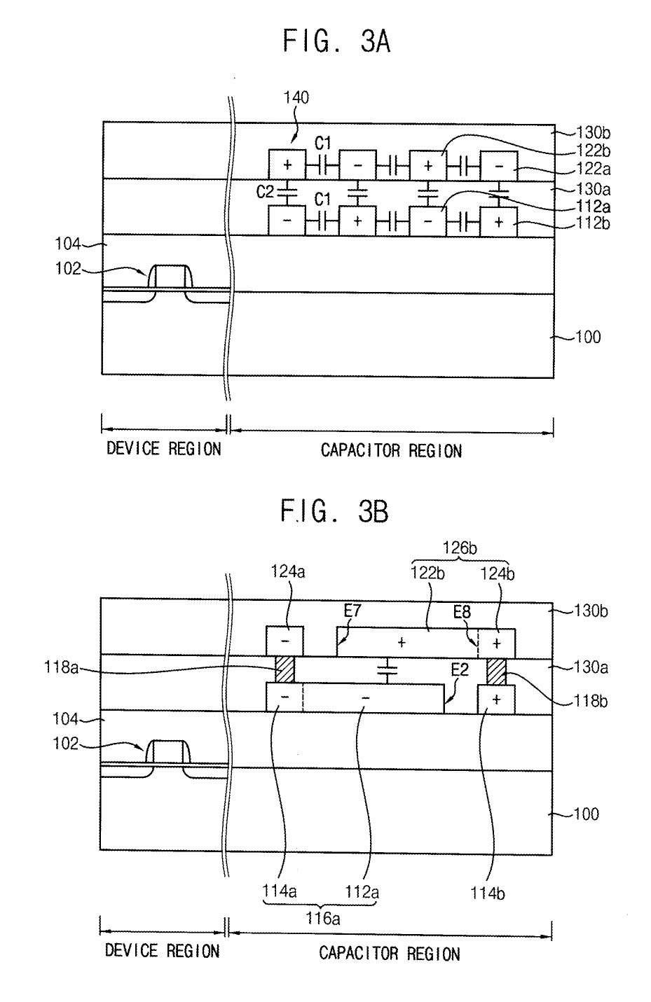

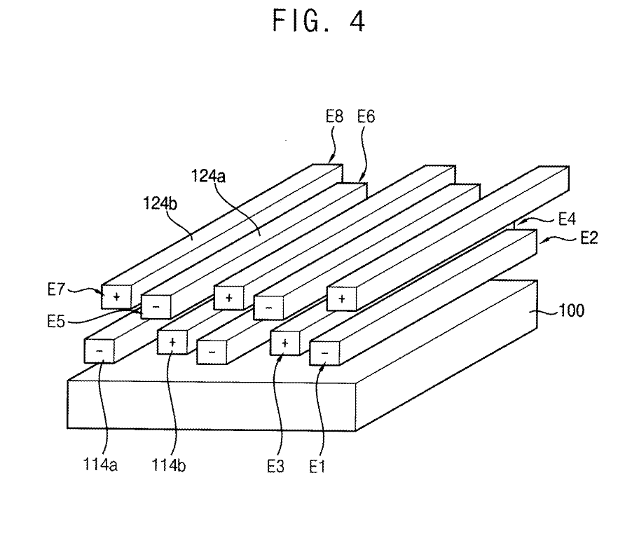

FIG. 1 is a plan view illustrating a capacitor structure in accordance with example embodiments. FIG. 2A is a plan view of a first electrode structure in the capacitor structure in FIG. 1. FIG. 2B is a plan view of a second electrode structure in the capacitor structure in FIG. 1. FIG. 3A is a first cross-sectional view of a semiconductor device which includes the capacitor structure in FIG. 1. FIG. 3B is a second cross-sectional view of the semiconductor device which includes the capacitor structure in FIG. 1. FIG. 4 is a perspective view illustrating plates in the capacitor structure in FIG. 1. FIG. 3A is a cross-sectional view cut along the line I-I′ in FIG. 1, and FIG. 3B is a cross-sectional view cut along the line II-II′ in FIG. 1.

In FIG. 1, in order to explain the first electrode and the second electrode, the first and second electrodes are shown to be shifted slightly in a horizontal direction. However, plates of the first electrode and the second electrode may be aligned in a vertical direction such that central portions of the plates overlap each other completely when viewed from a top side.

Referring to FIGS. 1 to 4, a substrate 100 having a device region and a capacitor region may be provided. On the device region of the substrate 100, lower devices 102 may be formed through a FEOL (Front End of Line) process. The lower devices 102 may include a MOS transistor, a diode, and/or wires connected thereto. A lower insulating interlayer 104 covering the lower devices 102 may he provided on the substrate 100. The lower devices 102 may not be formed on the capacitor region of the substrate 100.

A capacitor structure 140 may be provided on the lower insulating interlayer 104. The capacitor structure 140 may be formed by a BEOL (Back End of Line) process. The capacitor structure 140 may include a metal used in the BEOL process. First and second dielectric layers 130a and 130b included in the capacitor structure 140 may serve as intermetallic layers.

The capacitor structure 140 may include a plurality of first and second electrode structures 110 and 120 and first and second via contacts 118a and 118b. The first and second via contacts 118a and 118b may be electrically connected to the first and second electrode structures 110 and 120, respectively. In example embodiments, the capacitor structure 140 may include first and second electrode structures 110 and 120 stacked at two levels, for example, the capacitor structure 140 may include a first electrode structure 110 and a second electrode structure 120 over the first electrode structure 110. The number of the levels at which the electrode structures 110 and 120 are stacked may not be limited thereto.

The first electrode structure 110 may include first negative plates 112a, first positive plates 112b, a first negative connection pattern 114a, and a first positive connection pattern 114b. The first negative connection pattern 114a may electrically connect the first negative plates 112a to each other, and the first positive connection pattern 114b may electrically connect the first positive plates 112b to each other.

The first negative plates 112a and the first positive plates 112b may be alternately and repeatedly arranged in a first direction to be spaced apart from each other. A horizontal capacitance C1 may be formed between each first negative plate 112a and each first positive plate 112b.

Each of the first negative plates 112a and each of the first positive plates 112b may extend in a second direction substantially perpendicular to the first direction to have a linear shape.

Ends of the first negative plates 112a and the first positive plates 112b may not be aligned with each other in the first direction. That is, a first end E1 which is a left end of the first negative plate 112a and a third end E3 which is a left end of the first positive plate 112b may not be aligned with each other in the first direction. A second end E2 which is a right end of the first negative plate 112a and a fourth end E4 which is a right end of the first positive plate 112b may not be aligned with each other in the first direction. The first and third ends E1 and E3 may be arranged in a zigzag pattern in the first direction, and the second and fourth ends E2 and E4 may be arranged in a zigzag pattern in the first direction.

The first negative connection pattern 114a may be electrically connected to the first ends E1 of the first negative plates 112a. The first negative connection pattern 114a may extend in the first direction. The first negative plates 112a may extend in the second direction substantially perpendicular to the first direction in a horizontal plane. A first finger electrode 116a may include the first negative plates 112a and the first negative connection pattern 114a.

The first positive connection pattern 114b may be electrically connected to the fourth ends E4 of the first positive plates 112b. The first positive connection pattern 114b may extend in the first direction. The first positive plates 112b may extend in the second direction substantially perpendicular to the first direction in a horizontal plane. A second finger electrode 116b may include the first positive plates 112b and the first positive connection pattern 114b. The first positive plates 112b of the second finger electrode 116b may be inserted into a gap between the first negative plates 112a.

The second electrode structure 120 may be arranged to be spaced apart from the first electrode structure 110. The second electrode structure 120 may include second negative plates 122a, second positive plates 122b, a second negative connection pattern 124a, and a second positive connection pattern 124b. The second negative connection pattern 124a may electrically connect the second negative plates 122a to each other. The second positive connection pattern 124b may electrically connect the second positive plates 122b to each other.

The second negative plates 122a and the second positive plates 122b may be alternately and repeatedly arranged to be spaced apart from each other in the first direction. Each of the second negative plates 122a and each of the second positive plates 122b may extend in the second direction. A horizontal capacitance C1 may be formed between each second negative plate 122a and each second positive plate 122b.

Also, each plate of the first electrode structure 110 and each plate of the second electrode structure 120 may be arranged to form a vertical capacitance C2. Lower and upper plates facing each other in a third direction which is substantially perpendicular to a top surface of a substrate may have different polarities from each other.

For example, a portion of the second negative plate 122a may be arranged to overlap a portion of the first positive plate 112b. A portion of the second positive plate 122b may be arranged to overlap a portion of the first negative plate 112a. The vertical capacitances C2 may be formed between the second negative plate 122a and the first positive plate 112b, and between the second positive plate 122b and the first negative plate 112a, respectively.

To increase the vertical capacitance C2, sidewalls of the negative plates and the positive plates that are arranged in the third direction may be aligned in the third direction. Widths in the first direction of the negative plates and the positive plates may be substantially the same. Overlapping areas of the negative plates and the positive plates that may be arranged in the third direction may be increased so as to increase the vertical capacitance C2.

In example embodiments, in order to get a sufficiently high vertical capacitance in the capacitor structure, each of the overlapping areas of the lower and upper plates may be greater than about 50 percent of an area of a relatively small plate between the lower and upper plates.

Ends of the second negative plates 122a and the second positive plates 122b may not be aligned with each other in the first direction. For example, a fifth end E5 which is a left end of the second negative plate 122a and a seventh end E7 which is a left end of the second positive plate 122b may be arranged in a zigzag pattern. A sixth end E6 which is a right end of the second negative plate 122a and a eighth end E8 which is a right end of the second positive plate 122b may be arranged in a zigzag pattern.

The second negative connection pattern 124a may electrically connect the fifth ends E5 of the second negative plates 122a to each other. The second negative connection pattern 124a may face the first negative connection pattern 114a in the third direction. A third finger electrode 126a may include the second negative plates 122a and the second negative connection pattern 124a.

The second positive connection pattern 124b may electrically connect the eighth ends E8 of the second positive plates 122b. The second positive connection pattern 124b may extend in the first direction. A fourth finger electrode 126b may include the second positive plates 122b and the second positive connection pattern 124b. The second positive plates 122b of the fourth finger electrode 126b may be inserted into a gap between the second negative plates 122a.

The first and second dielectric layers 130a and l30b may be provided between the negative plates 112a and 122a and the positive plates 112b and 122b so that the negative plates 112a and 122a and the positive plates 112b and 122b may be insulated from each other. Wires (e.g., via contacts) may not be provided between the plates facing each other in the third direction.

A first via contact 118a may electrically connect the negative plates arranged at a plurality of levels to each other. A second via contact 118b may electrically connect the positive plates arranged at a plurality of levels to each other.

The first via contact 118a may be provided between the first and second negative connection patterns 114a and 124a. The second via contact 118b may be provided between the first and second positive connection patterns 114b and 124b. In example embodiments, a plurality of first via contacts 118a and a plurality of second via contacts 118b may be provided.

The first negative plates 112a in the capacitor structure 140 may be electrically connected to each other horizontally through the first negative connection pattern 114a, and the second negative plates 122a in the capacitor structure 140 may be electrically connected to each other horizontally through the second negative connection pattern 124a. The first and second negative plates 112a and 122a may be electrically connected to each other vertically through the first via contact 118a. The negative plates 112a and 122a in the capacitor structure 140 may serve as one electrode, that is, a first electrode.

The first positive plates 112b in the capacitor structure 140 may be electrically connected to each other horizontally through the first positive connection pattern 114b, and the second positive plates 122b in the capacitor structure 140 may be electrically connected to each other horizontally through the second positive connection pattern 124b. The first and second positive plates 112b and 122b may be electrically connected to each other vertically through the second via contact 118b. The positive plates 112b and 122b in the capacitor structure 140 may serve as one electrode, that is, a second electrode.

Hereinafter, the plates, the connection patterns and the via contacts in each of the first and second electrode structures 110 and 120 may be illustrated in detail.

In the first electrode structure 110, each first end E1 of the first negative plate 112a may protrude from each third end E3 of the first positive plate 112b in the second direction. Thus, the first negative connection pattern 114a which is electrically connected to the first ends E1 of the first negative plate 112a may not be electrically connected to the first positive plate 112b.

Each fourth end E4 of the first positive plate 112b may protrude from each second end E2 of the first negative plate 112a in the second direction. Thus, the first positive connection pattern 114b which is electrically connected to the fourth ends E4 of the first positive plate 112b may not be electrically connected to the first negative plate 112a.

The first negative connection pattern 114a and the first positive connection pattern 114b may be arranged to face each other in the second direction.

As illustrated in FIGS. 2A and 2B, each first negative plate 112a may have a first width in the first direction. Each first positive plate 112b may have a first width in the first direction. The first negative plate 112a and the first positive plate 112b may be spaced apart from each other at a given distance, however, the width and the distance between the first negative plate 112a and the first positive plate 112b may not be limited thereto.

In the second electrode structure 120, each fifth end E5 of the second negative plate 122a may protrude from each seventh end E7 of the second positive plate 122b in the second direction. Thus, the second negative connection pattern 124a which is electrically connected to the fifth ends E5 of the second negative plate 122a may not be electrically connected to the second positive plate 122b.

A portion of the first positive plate 112b adjacent to the third end E3 and a portion of the second negative plate 122a adjacent to the fifth end E5 may not overlap each other. A portion of the first positive plate 112b adjacent the fourth end E4 and a portion of the second negative plate 122a adjacent the sixth end E6 may not overlap each other.

Each eighth end E8 of the second positive plate 122b may protrude from each sixth end E6 of the second negative plate 122a in the second direction. Thus, the second positive connection pattern 124b which is electrically connected to the eighth ends E8 of the second positive plate 122b may not be electrically connected to the second negative plate 122a.

A portion of the first negative plate 112a adjacent to the first end E1 and a portion of the second positive plate 122b adjacent to the seventh end E7 may not overlap each other. A portion of the first negative plate 112a adjacent the second end E2 and a portion of the second positive plate 122b adjacent the eighth end E8 may not overlap each other.

The negative and positive plates 112a, 112b, 122a and 122b, the negative and positive connection patterns 114a, 114b, 124a and 124b, and the first and second via contacts 118a and 118b may include a conductive material. For example, the negative and positive plates 112a, 112b, 122a and 122b. the negative and positive connection patterns 114a, 114b, 124a and 124b, and the first and second via contacts 118a and 118b may include metal.

In the capacitor structure 140 described above, the horizontal capacitance C 1 between plates having polarities different from each other at the same level and the vertical capacitance C2 between plates at different levels having polarities different from each other may be formed. Thus, the capacitor structure 140 may have a relatively high capacitance.

The capacitor structure 140 in FIG. 1 may be manufactured by various methods.

In example embodiments, a FEOL process may be performed to form lower devices 102 on a substrate 100. A lower insulating interlayer 104 may be formed to cover the lower devices 102.

A first electrode structure 110 may be formed on the lower insulating interlayer 104. The first electrode structure 110 may include metal. The first electrode structure 110 may be formed by forming and patterning a conductive layer. Alternatively, a damascene process may be performed to form the first electrode structure 110. The first electrode structure 110 may have a shape as shown in FIG. 2A.

A first dielectric layer 130a may be formed between patterns of the first electrode structure 110 and on the first electrode structure 110. The first dielectric layer 130a may serve as an insulating interlayer.

The first dielectric layer 130a may be partially etched to form via holes. The via holes may be filled with a conductive material to form first and second via contacts 118a and 118b. The first via contact 118a may be formed on the first negative connection pattern 114a. The second via contact 118b may be formed on the positive connection pattern 114b.

A second electrode structure 120 may be formed on the first dielectric layer 130a. The second electrode structure 120 may have a shape as shown in FIG. 2B. A second negative connection pattern 124a in the second electrode structure 120 may be formed to be electrically connected to a top surface of the first via contact 118a. A second positive connection pattern 124b in the second electrode structure 120 may be formed to be electrically connected to a top surface of the second via contact 118b.

A second dielectric layer 130b may be formed between patterns of the second electrode structure 120 and on the second electrode structure 120. The second dielectric layer 130b may serve as an insulating interlayer.

By performing the processes above, the capacitor structure in FIG. 1 may be manufactured.

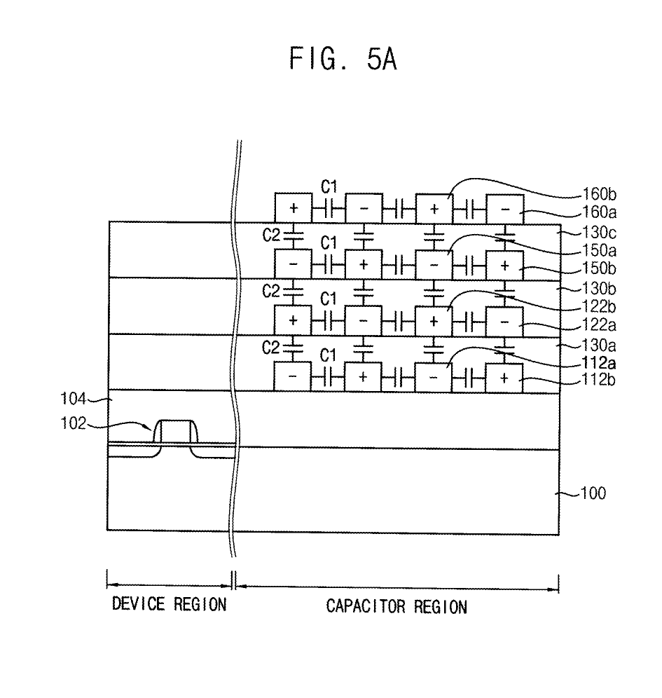

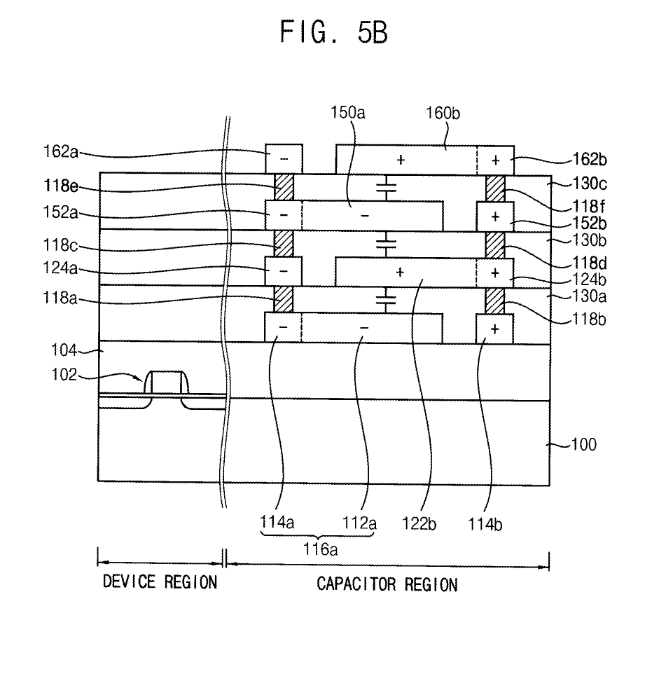

FIGS. 5A and 5B are cross-sectional views of a semiconductor device which includes a capacitor structure in accordance with example embodiments. The capacitor structure in FIGS. 5A and 5B may further include a third electrode structure and a fourth electrode structure sequentially stacked on the capacitor structure of FIG. 1. Additionally, the semiconductor device may include via contacts which electrically connect the electrode structures to each other.

Referring to FIGS. 5A and 5B, the capacitor structure may include the first electrode structure 110, the second electrode structure 120 and the first and second via contacts 118a and 118b shown in FIG. 1.

The third electrode structure may be provided on the second dielectric layer 130b covering the second electrode structure 120. The third electrode structure may include third negative plates 150a, third positive plates 150b, a third negative connection pattern 152a, and a third positive connection pattern 152b. The third negative connection pattern 152a may electrically connect the third negative plates 150a to each other, and the third positive connection pattern 152b may electrically connect the third positive plates 150b to each other.

Third via contacts 118c which electrically connect the second and third negative connection patterns 124a and 152a may be provided. Fourth via contacts 118d which electrically connect the second and third positive connection patterns 124b and 152b may be provided.

A shape of the third electrode structure may be substantially the same as that of the first electrode structure 110. That is, shapes of the third negative plates 150a and the third positive plates 150b may be substantially the same as those of the first negative plates 112a and the first positive plates 112b, respectively. The third negative connection pattern 152a may be electrically connected to left ends of the third negative plates 150a. The third negative connection pattern 152a may be aligned with the first and second negative connection patterns 114a and 124a in the third direction. The third positive connection pattern 152b may be electrically connected to right ends of the third positive plates 150b. The third positive connection pattern 152b may be aligned with the first and second positive connection patterns 114b and 124b in the third direction.

A horizontal capacitance C1 may be formed between each third negative plate 150a and each third positive plate 150b. Vertical capacitances C2 may be formed between each second negative plate 122a and each third positive plate 150b and between each second positive plate 122b and each negative plate 150a.

A third dielectric layer 130c may be provided on the third electrode structure to fill spaces between the third negative plates 150a and the third positive plates 150b. The third dielectric layer 130c may serve as an insulating interlayer.

The third via contact 118c may electrically connect the second and third negative connection patterns 124a and 152a. In example embodiments, a plurality of third via contacts 118c may be provided.

The fourth via contact 118d may electrically connect the second and third positive connection patterns 124b and 152b. In example embodiments, a plurality of fourth via contacts 118d may be provided.

The fourth electrode structure may be provided on the third dielectric layer 130c covering the third electrode structure. The fourth electrode structure may include fourth negative plates 160a and fourth positive plates 160b. A fourth negative connection pattern 162a, a fourth positive connection pattern 162b, and fifth and sixth via contacts 118e and 118f may be provided.

A shape of the fourth electrode structure may be substantially the same as that of the second electrode structure 120. That is, shapes of the fourth negative plates 160a and the fourth positive plates 160b may be substantially the same as those of the second negative plates 122a and the second positive plates 122b, respectively. The fourth negative connection pattern 162a may be electrically connected to left ends of the fourth negative plates 160a. The fourth negative connection pattern 162a may be aligned with the first to third negative connection patterns 114a, 124a and 152a in the third direction. The fourth positive connection pattern 162b may be electrically connected to right ends of the fourth positive plates 160b. The fourth positive connection pattern 162b may be aligned with the first to third positive connection patterns 114b, 124b and 124b in the third direction.

A horizontal capacitance C1 may be formed between each fourth negative plate 160a and each fourth positive plate 160b. Vertical capacitances C2 may be formed between each third negative plate 150a and each fourth positive plate 160b, and between each third positive plate 150b and each negative plate 160a.

A dielectric layer (not shown) may be provided on the fourth electrode structure to fill spaces between the fourth negative plates 160a and the fourth positive plates 160b. The dielectric layer may serve as an insulating interlayer.

The fifth via contact 118e may electrically connect the third and fourth negative connection patterns 152a and 162a. In example embodiments, a plurality of fifth via contacts 118e may be provided.

The sixth via contact 118f may electrically connect the third and fourth positive connection patterns 152b and 162b. In example embodiments, a plurality of sixth via contacts 118f may be provided.

In the capacitor structure, electrode structures substantially the same as the first electrode structure 110 may be provided at odd levels, respectively, and electrode structures substantially the same as the second electrode structure 120 may be provided at even levels, respectively. Additionally, via contacts may be further provided between connection patterns at different levels.

Due to the electrode structures repeatedly stacked on each other, for example, the first and second electrode structures 110 and 120, the capacitance of the capacitor structure may be increased.

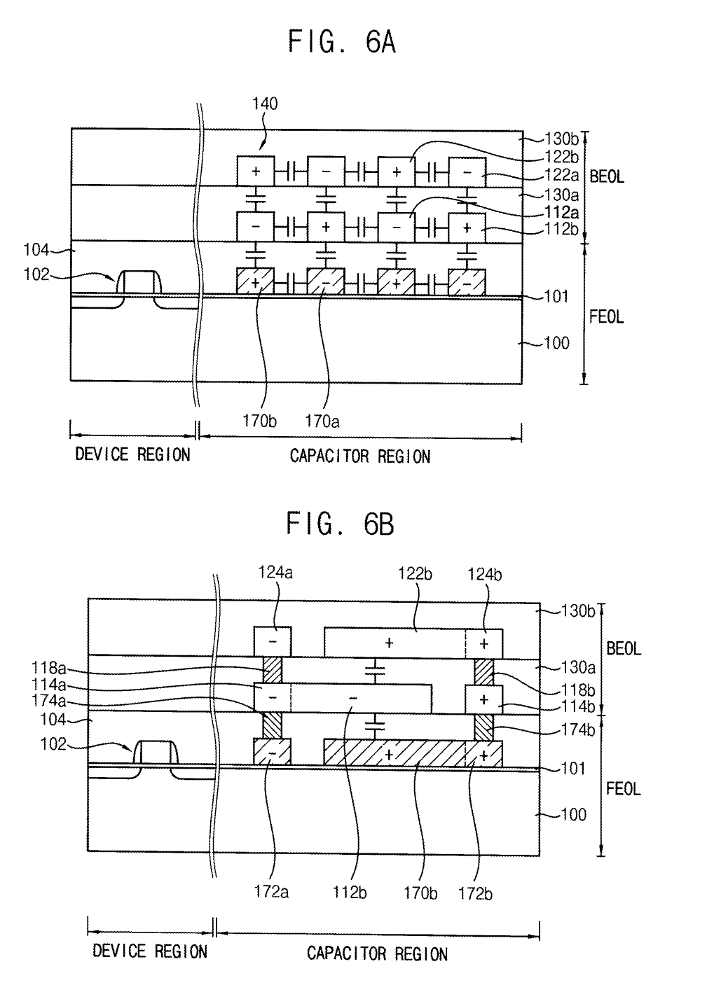

FIGS. 6A and 6B are cross-sectional views of a semiconductor device which includes a capacitor structure in accordance with example embodiments.

Referring to FIGS. 6A and 6B, a substrate 100 having a device region and a capacitor region may be provided. On the device region of the substrate 100, lower devices 102 may be formed through a FEOL (Front End of Line) process. The lower devices 102 may include a MOS transistor, a diode, and/or wires connected thereto.

An insulation layer 101 may be provided on the capacitor region of the substrate 100. A lower electrode structure and lower contacts 174a and 174b may be provided on the insulation layer 101. The lower electrode structure and the lower contacts 174a and 174b may be formed in the FEOL process. The lower electrode structure and the lower contacts 174a and 174b may include a conductive material (e.g., polysilicon).

The lower electrode structure may include first lower electrodes 170a, second lower electrodes 170b, a first lower line 172a and a second lower line 172b. A signal having a negative polarity may be supplied to the first lower electrodes 170a. A signal having a positive polarity may be supplied to the second lower electrodes 170b. The first lower electrodes 170a and the second lower electrodes 170b may be alternately and repeatedly arranged in the first direction. Each of the first lower electrodes 170a and each of the second lower electrodes 170b may extend in the second direction. A horizontal capacitance C3 may be formed between each first lower electrode 170a and each second lower electrode 170b.

Left ends of the first lower electrodes 170a and the second lower electrodes 170b may not be aligned with each other in the first direction. Right ends of the first lower electrodes 170a and the second lower electrodes 170b may not be aligned with each other in the first direction. In example embodiments, the left ends of the first lower electrodes 170a may protrude from the left ends of the second lower electrodes 170b in the second direction. The right ends of the second lower electrodes 170b may protrude from the right ends of the first lower electrodes 170a in the second direction.

The first lower line 172a may extend in the first direction. The first lower line 172a may electrically connect the first lower electrodes 170a to each other. The second lower line 172b may extend in the first direction. The second lower line 172b may electrically connect the second lower electrodes 170b to each other.

The first and second lower electrodes 170a and 170b may have substantially the same structure and arrangement as those of the second negative plates 122a and the second positive plates 122b included in the second electrode structure 120 in FIG. 1. The first and second lower lines 172a and 172b may have substantially the same structure and arrangement as those of the second negative connection pattern 124a and the second positive connection pattern 124b.

The lower devices and the lower electrode structures may be covered by a lower insulating interlayer 104. The insulating interlayer 104 between the first and second lower electrodes 170a and 170b may serve as a dielectric layer.

Electrode structures at a plurality of levels may be provided on the insulating interlayer 104. Via contacts may electrically connect the electrode structures to each other. The electrode structures and the via contacts on the insulating interlayer 104 may be formed by the BEOL process. The electrode structures and the via contacts may include a metal.

The electrode structures and the via contacts may have substantially the same structures as those illustrated with reference to FIG. 1. The electrode structures and the via contacts may be arranged to form vertical capacitances.

That is, a portion of first negative plate 112a may overlap a portion of the second lower electrode 170b. The overlapping area of the first negative plate 112a and the second lower electrode 170b may be greater than about 50 percent of an area of a relatively small pattern between the first negative plate 112a and the second lower electrode l70b. A portion of first positive plate 112b may overlap a portion of the first lower electrode 170a. The overlapping area of the first positive plate 112b and the first lower electrode 170a may be greater than about 50 percent of an area of a relatively small pattern between the first positive plate 112b and the first lower electrode 170a.

The first lower line 172a may face the first negative connection pattern 114a in the third direction. The second lower line 172b may face the first positive connection pattern 114b in the third direction.

A first lower contact 174a may be provided between the first lower line 172a and the first negative connection pattern 114a. The first lower contact 174a may electrically connect the first lower line 172a to the first negative connection pattern 114a. The first lower electrodes 170a formed in the FEOL process and the negative plates 112a and 122a at levels formed in the BEOL process may be electrically connected to each other to serve as one negative electrode.

The second lower contact 174b may be provided between the second lower line 172b and the first positive connection pattern 114b. The second lower contact 174b may electrically connect the second lower line 172b to the first positive connection pattern 114b.

The second lower electrodes 170b formed in the FEOL process and the positive plates 112b and 122b at levels formed in the BEOL process may be electrically connected to each other to serve as one positive electrode.

As the capacitor structure in accordance with example embodiments may further include electrode patterns formed in the FEOL process, horizontal and vertical capacitances may be increased. The capacitor structure in accordance with example embodiments may have a relatively high capacitance.

The capacitor structure in FIGS. 6A and 6B may be manufactured by various methods.

In example embodiments, an insulation layer 101 may be formed on a substrate 100. Lower devices 102, a lower electrode structure and lower contacts 174a and 174b may be formed on the insulation layer 101. A process for depositing and patterning a polysilicon layer may be performed to form gates of the lower devices and the lower electrode structure. The lower electrode structure may be formed to have substantially the same structure and arrangement as those of the second electrode structure 120 in FIG. 2B. A lower insulating interlayer 104 may be formed to cover the lower devices 102 and the lower electrode structure. The lower insulating interlayer 104 may be partially etched to form contact holes. The contact holes may be filled with a conductive material to form lower contacts 174a and 174b. The lower contacts 174a and 174b may contact the first and second lower lines 172a and 172b, respectively.

A first electrode structure 110, a first dielectric layer 130a, and first and second via contacts 118a and 118b may be formed by substantially the same processes as those described above. A second electrode structure 120 and a second dielectric layer 130b may be formed.

By performing the processes above, the capacitor structure in FIGS. 6A and 6B may be manufactured.

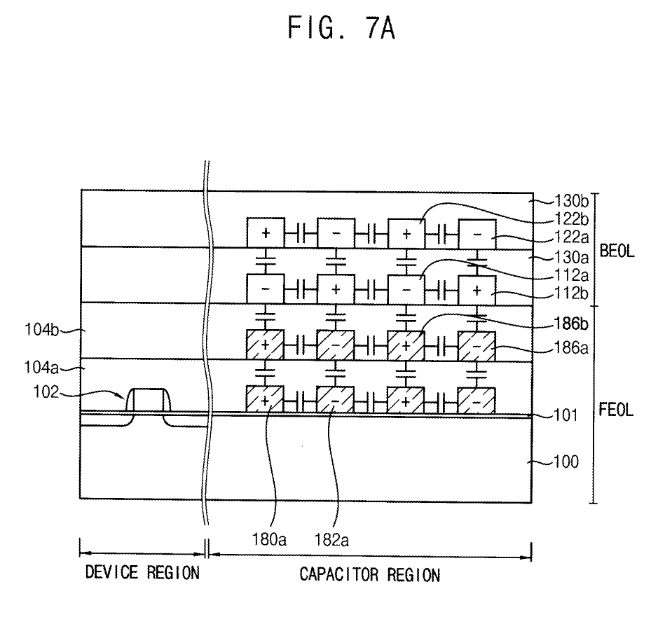

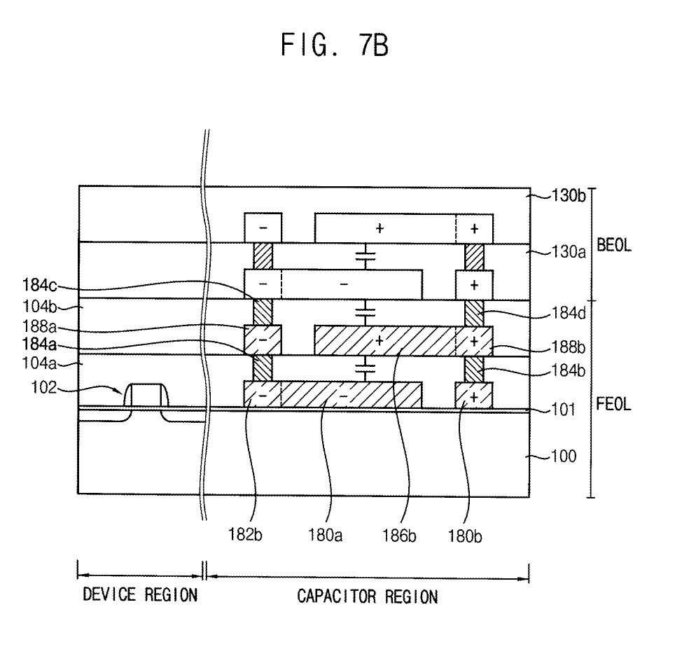

FIGS. 7A and 7B are cross-sectional views of a semiconductor device which includes a capacitor structure in accordance with example embodiments.

Referring to FIGS. 7A and 7B, a substrate 100 having a device region and a capacitor region may be provided. On the device region of the substrate 100, lower devices 102 may be formed through a FEOL (Front End of Line) process. An insulation layer 101 may be provided on the capacitor region of the substrate 100. Lower electrode structures and first to fourth lower contacts 184a, 184b, 184c and 184d may be provided on the insulation layer 101.

The lower devices 102, the lower electrode structures and the lower contacts 184a, 184b, 184c and 184d may include a conductive material used in a FEOL process. That is, the lower electrode structures and the first to fourth lower contacts 184a, 184b, 184c and 184d may be formed in the FEOL process. The conductive material may include polysilicon. The lower electrode structures may have a structure stacked at least two levels.

A first lower electrode structure provided on the substrate 100 may include first lower electrodes 180a having a negative polarity, a first lower line 182a, second lower electrodes 180b having a positive polarity, and a second lower line 182b. The first lower electrode structure may have substantially the same shape as that of the first electrode structure 110 with reference to FIG. 1.

A second lower electrode structure provided on the first lower electrode structure may include third lower electrodes 186a having a negative polarity, a third lower line 188a, fourth lower electrodes 186b having a positive polarity, and a fourth lower line 188b. The second lower electrode may have substantially the same shape as that of the second electrode structure 120 with reference to FIG. 1. An electrode structure substantially the same as the first and second electrode structures may be alternately and repeatedly stacked on the second lower electrode structure.

The lower devices 102 and the lower electrode structures may be covered by lower insulating interlayers 104a and 104b. The lower insulating interlayers 104a and 104b may serve as dielectric layers.

The first lower contact 184a may electrically connect the first and third lower lines 182a and 188a to each other. The second lower contact 184b may electrically connect the second and fourth lower lines 182b and 188b to each other. The third lower contact 184c may electrically connect the third lower line 188a to the first negative connection pattern 144a. The fourth lower contact 184d may electrically contact the fourth lower line 188b to the first positive connection pattern 114b.

The electrode structures and the via contacts may be provided at a plurality of levels on the lower insulating interlayers 104a and 104b. The electrode structures and the via contacts on the lower insulating interlayers 104a and 104b may be substantially the same as those illustrated with reference to FIG. 1. The first electrode structure 110 may be arranged to form a vertical capacitance between the lower electrode structure at an uppermost level and the first electrode structure 110. The electrode having a negative polarity and the electrode having a positive polarity may be arranged to face each other in the third direction.

The capacitor structure in accordance with example embodiments may further include horizontal and vertical capacitances by the lower electrode structures formed in the FEOL process. The capacitor structure in accordance with example embodiments may have a relatively high capacitance.

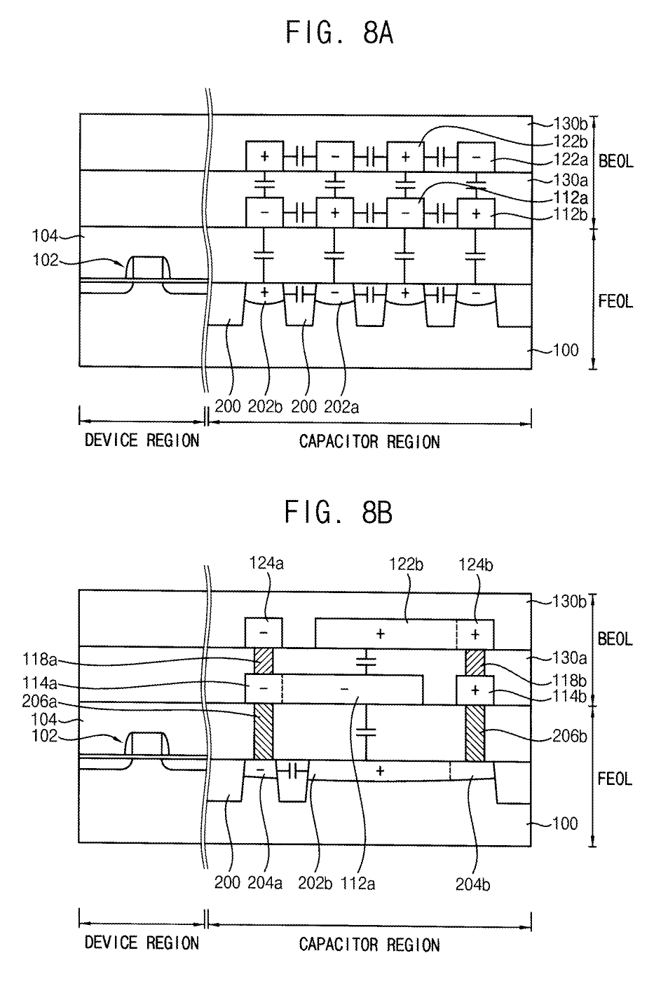

FIGS. 8A and 8B are cross-sectional views of a semiconductor device which includes a capacitor structure in accordance with example embodiments.

Referring to FIGS. 8A and 8B, a substrate 100 having a device region and a capacitor region may be provided. On the device region of the substrate 100, lower devices 102 may be formed through a FEOL (Front End of Line) process.

The capacitor region of the substrate 100 may be divided into an active region and an isolation region. The active region of the substrate 100 may be doped or undoped with impurities. The active region of the substrate 100 may serve as a portion of an electrode of the capacitor structure. An insulation layer may be provided on the isolation region 200. The insulation layer may serve as a dielectric layer of a capacitor. A horizontal capacitance may be formed between the active regions.

In particular, the active region may include first active patterns 202a serving as an electrode having a negative polarity, second active patterns 202b serving as an electrode having a positive polarity, a first line pattern 204a electrically connecting the first active patterns 202a to each other, and a second line pattern 204b electrically connecting the second active patterns 202b to each other.

Each of the first and second active patterns 202a and 202b may extend in the second direction. The first and second active patterns 202a and 202b may be arranged in the first direction alternately and repeatedly. A horizontal capacitance may be formed between the first and second active patterns 202a and 202b spaced apart from each other in the first direction. The first line pattern 204a may electrically connect ends of the first active patterns 202a. The first line pattern 204a may extend in the first direction. The second line pattern 204b may electrically connect ends of the second active patterns 202b. The second line pattern 204b may extend in the first direction.

In example embodiments, the first active patterns 202a and the first line pattern 204a, and the first active patterns 202b and the second line pattern 204b may have substantially the same structure and arrangement as those of the second electrode in FIG. 1.

The lower devices 102 may be covered by a lower insulating interlayer 104.

Electrode structures at a plurality of levels and via contacts electrically connecting the electrode structures to each other may be provided on the lower insulating interlayer 104. First and second lower contacts 206a and 206b may electrically connect the electrode structures and the lower active patterns to each other. The first lower contacts 206a may electrically connect first negative connection patterns 114a to a first line pattern 204a on the substrate 100. The second lower contacts 206b may electrically connect first positive connection patterns 114b to a second line pattern 204b.

The electrode structure on the lower insulating interlayer 104 may have substantially the same structure as that of the electrode structure with reference to FIG. 1. The lower electrode structure and the first electrode structure may be arranged to form a vertical capacitance. A portion of the first negative plate 112a may overlap a portion of the second active pattern 202b in the third direction. A portion of the first positive plate 112b may overlap a portion of the first active pattern 202a in the third direction.

The first negative connection pattern 114a may face the first line pattern 204a in the third direction. The second positive connection pattern 124b may face the second line pattern 204b in the third direction.

As the active patterns at the substrate 100 may be used as a portion of an electrode in the capacitor structure in accordance with example embodiments, the horizontal and vertical capacitances may be increased, and the capacitor structure may have a relatively high capacitance.

The capacitor structure shown in FIGS. 8A and 8B may be manufactured by various methods.

In example embodiments, a substrate 100 may be divided into an active region and an isolation region by a shallow trench isolation (STI) process. The active region on a capacitor region of the substrate 100 may be formed to have a structure and an arrangement substantially the same as those of the second electrode structure 120 in FIG. 2B. The active region may serve as a portion of an electrode of a capacitor. Impurities may be implanted into the active region.

A lower insulating interlayer 104 may be formed to cover the substrate 100. The lower insulating interlayer 104 may be etched partially to form contact holes. The contact holes may be filled with a conductive material to form lower contacts 206a and 206b. The lower contacts 206a and 206b may contact the first and second line patterns 204a and 204b in the active region.

A first electrode structure 110, a first dielectric layer 130a, and first and second via contacts 118a and 118b may be formed on the lower insulating interlayer 104 by processes substantially the same as those described above. A second electrode structure 120 and a second dielectric layer 130b may be formed. By performing the processes above, the capacitor structure in FIGS. 8A and 8B may be manufactured.

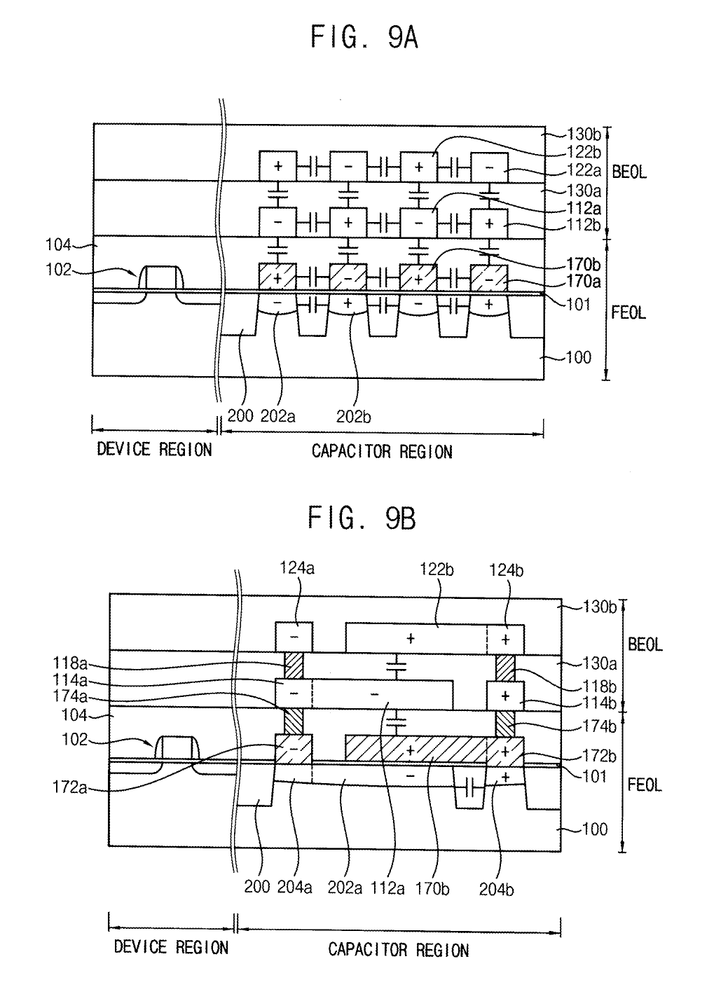

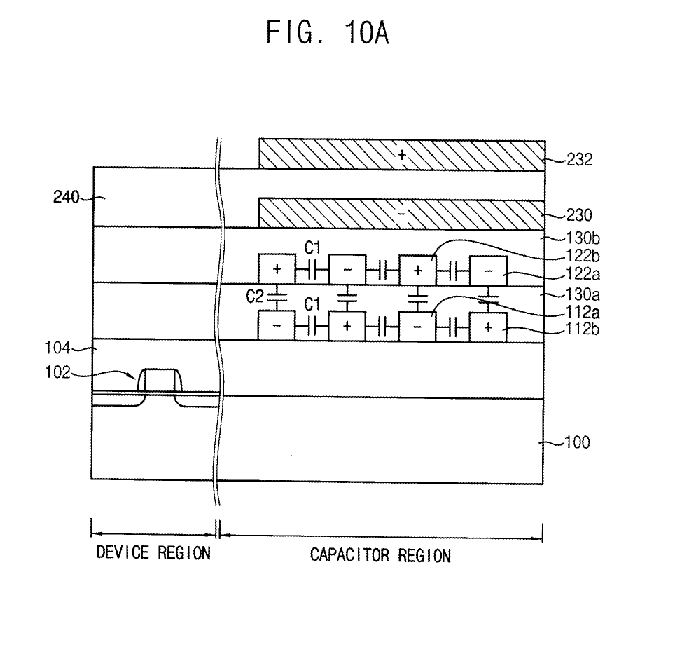

FIGS. 9A and 9B are cross-sectional views of a semiconductor device which includes a capacitor structure in accordance with example embodiments.

Referring to FIGS. 9A and 9B, a substrate 100 having a device region and a capacitor region may be provided. The capacitor region of the substrate 100 may be divided into an active region and an isolation region. The active region of the substrate 100 may be doped with impurities or not. The active region of the substrate 100 may serve as a portion of an electrode of the capacitor structure.

A first active pattern 202a to which a signal of a negative polarity is supplied, and a second active pattern 202b to which a signal of a positive polarity is supplied may be arranged alternately and repeatedly in the first direction. The active region and the isolation region may have substantially the same structures as those of the active region and the isolation region with reference to FIGS. 8A and 8B.

An insulation layer 101 may be provided on the active region. The insulation layer 101 provided between the active region and lower electrodes may serve as a dielectric layer of a capacitor.

Lower electrode structures, and lower contacts 174a and 174b may be provided on the insulation layer 101. The lower electrode structures, and the lower contacts 174a and 174b may include a conductive material used in a FLOL process. The conductive material may include polysilicon. The lower electrode structures may have a stacked structure at one or more than one levels.

A first lower electrode 170a to which a signal of a negative polarity is supplied, and a second lower electrode 170b to which a signal of a positive polarity is supplied may be arranged in the first direction, alternately and repeatedly. The first active pattern 202a may face the second lower electrode 170b in the third direction. The second active pattern 202b may face the first lower electrode 170a in the third direction. Vertical capacitances may be formed between the active patterns 202a and 202b, and the lower electrodes 170a and 170b, respectively.

The first line pattern 204a and the first lower line 172a may be electrically connected to each other. The second line pattern 204b and the second lower line 172b may be electrically connected to each other.

A first lower contact 174a may electrically connect the first lower line 172a and a first negative plate 112a to each other. A second lower contact 174b may electrically connect the second lower line 172b and a positive plate 112b to each other. The lower devices and the lower electrode structures may be covered by a lower insulating interlayer 104.

Electrode structures at a plurality of levels and first and second via contacts 118a and 118b may be provided on the lower insulating interlayer 104. The electrode structures, and the first and second via contacts 118a and 118b may include a metal used in the BEOL process.

The electrode structures and the via contacts may have substantially the same structures as those of the electrode structures and the via contacts in FIG. 1. The first electrode structures may be arranged to form a vertical capacitance between the lower electrode structures. That is, an electrode having a negative polarity and an electrode having a positive polarity may face each other in the third direction.

In the capacitor structure in accordance with example embodiments, horizontal and vertical capacitances may be formed by the active pattern and the lower electrode structures formed in the FEOL process. The capacitor structure in accordance with example embodiments may have a relatively high capacitance.

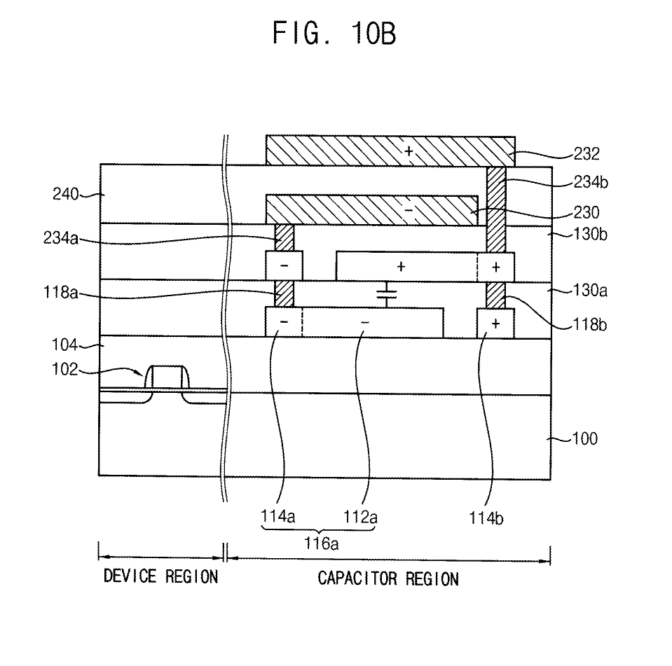

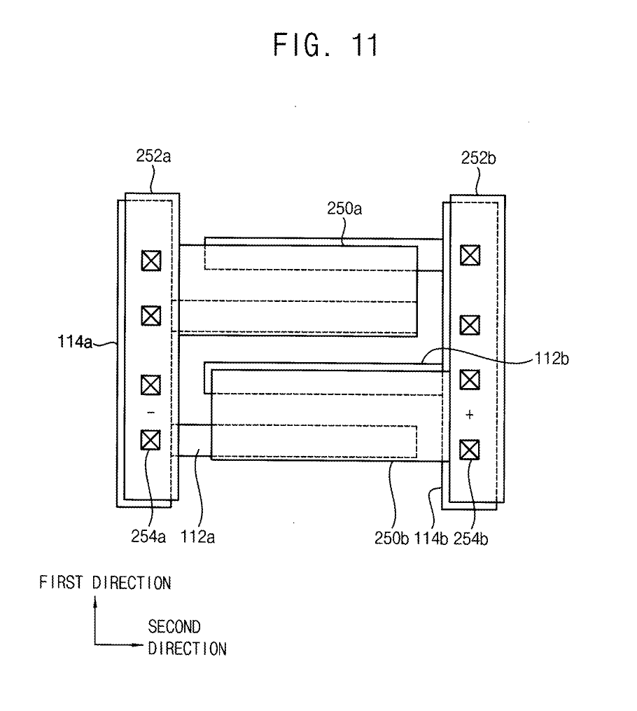

FIGS. 10A and 10B are cross-sectional views of a semiconductor device which includes a capacitor structure in accordance with example embodiments.

Referring to FIGS. 10A and 10B, the capacitor structure in FIG. 1 may be provided on a substrate 100.

As illustrated in FIG. 1, negative plates 112a and 122a in the capacitor structure may be electrically connected to each other to serve as one electrode, that is, a first electrode. Positive plates 112b and 122b in the capacitor structure may be electrically connected to each other to serve as one electrode, that is, a second electrode. The capacitor structure may have a horizontal capacitance and a vertical capacitance at each level.

A MIM capacitor may be provided on a second dielectric layer 130b covering the capacitor structure. In the MIM capacitor, a lower planar electrode 230, a dielectric layer 240 and an upper planar electrode 232 may be stacked.

A first upper via contact 234a may be provided between the lower electrode 230 and a second negative connection pattern 124a. A second upper via contact 234b may be provided between the upper electrode 232 and the second positive connection pattern 124b. The lower electrode 230 may be electrically connected to the first electrode, and the upper electrode 232 may be electrically connected to the second electrode. As the MIM capacitor is provided on the vertical native capacitor structure, more capacitance may be gained.

The structure of the vertical native capacitor structure may not be limited to that of the capacitor structure in FIG. 1. The vertical native capacitor structure may be replaced by the capacitor structure in accordance with example embodiments.

A vertical native capacitor structure may be further stacked on the MIM capacitor. That is, the vertical native capacitor structure and the MIM capacitor may be multi-stacked in the capacitor structure.

FIG. 11 is a plan view illustrating a semiconductor device which includes a capacitor structure in accordance with example embodiments.

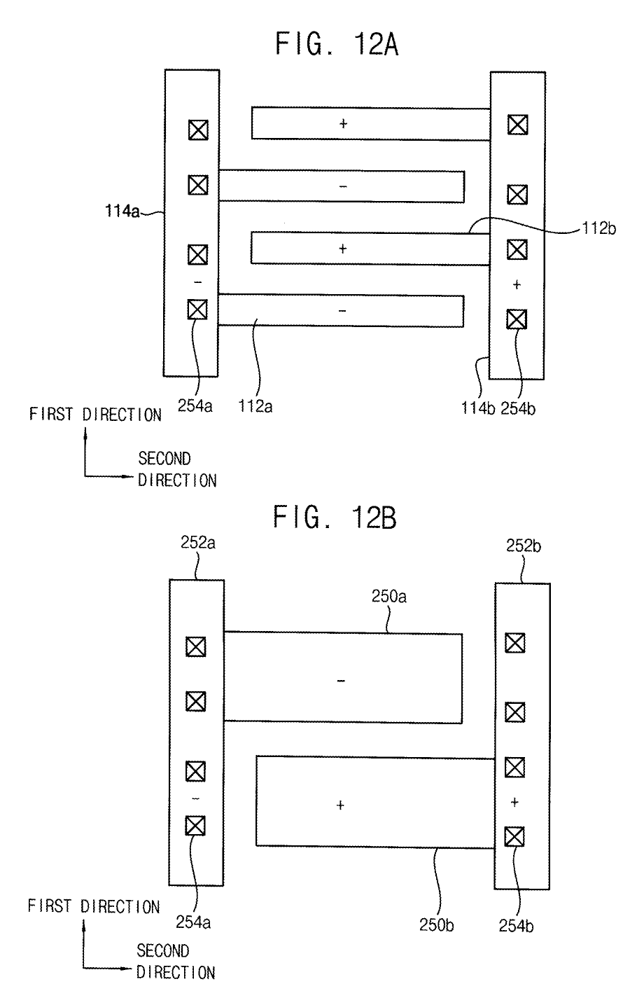

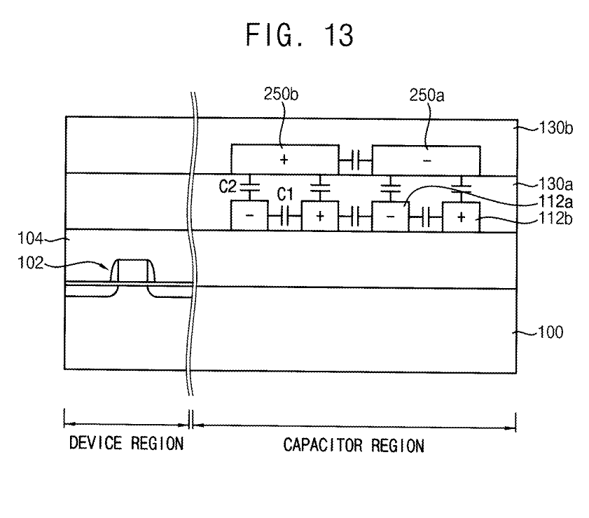

FIG. 12A is a plan view of a first electrode structure in the capacitor structure in FIG. 11. FIG. 12B is a plan view of a second electrode structure in the capacitor structure in FIG. 11. FIG. 13 is a cross-sectional view of the semiconductor device which includes the capacitor structure of FIG. 11.

In FIG. 11, in order to explain the first electrode and the second electrode, the first and second electrodes are shown to be shifted slightly in a horizontal direction. However, plates of the first electrode and the second electrode may be aligned in a vertical direction.

Referring to FIGS. 11 to 13, a substrate 100 having a device region and a capacitor region may be provided. A lower insulating interlayer 104 may be provided on the substrate 100.

A capacitor structure 140 may be provided on the lower insulating interlayer 104. The capacitor structure may include a plurality of electrode structures, and via contacts electrically connecting the electrode structures to each other. In example embodiments, the capacitor structure may include a first electrode structure and a second electrode structure over the first electrode structure. Electric signals may be supplied to the first and second electrode structure to form a capacitance.

The first electrode structure may include first negative plates 112a, first positive plates 112b, a first negative connection pattern 114a, and a first positive connection pattern 114b. The first negative connection pattern 114a may electrically connect the first negative plates 112a to each other, and the first positive connection pattern 114b may electrically connect the first positive plates 112b to each other.

The first negative plates 112a and the first positive plates 112b may be alternately and repeatedly arranged in a first direction to be spaced apart from each other. A horizontal capacitance may be formed between each first negative plate 112a and each first positive plate 112b. Each first negative plate 112a and each first positive plate 112b may have a first width in the first direction.

The first negative connection pattern 114a may be electrically connected to left ends of the first negative plates 112a. The first negative connection pattern 114a may extend in the first direction. The first positive connection pattern 114b may be electrically connected to right ends of the first positive plates 112b. The first positive connection pattern 114b may extend in the first direction. In example embodiments, the first electrode structure may have substantially the same shape and arrangement as those of the first electrode structure in FIG. 1.

The second electrode structure may include a second negative plate 250a, a second positive plate 250b, a second negative connection pattern 252a, and a second positive connection pattern 252b. The second negative plate 250a and the second positive plate 250b may be alternately and repeatedly arranged to be spaced apart from each other in the first direction. A horizontal capacitance may be formed in the second electrode structure. The second negative plate 250a and the second positive plate 250b may have a second width greater than the first width in the first direction.

A portion of the second negative plate 250a may be arranged to overlap a portion of the first positive plate 112b. As the second negative plate 250a may have the second width greater than the first width of the first positive plate 112b, a portion of the second negative plate 250a may also overlap a portion of the first negative plate 112a. A vertical capacitance may be formed at the portions of the second negative plate 250a and the first positive plate 112b facing each other.

A portion of the second positive plate 250b may be arranged to overlap a portion of the first negative plate 112a. As the second positive plate 250b may have the second width greater than the first width of the first negative plate 112a, a portion of the second positive plate 250b may also overlap a portion of the first positive plate 112b. A vertical capacitance may be formed at the portions of the second positive plate 250b and the first negative plate 112a facing each other.

The second negative connection pattern 252a may electrically connect the second negative plates 250a to each other, and the second positive connection pattern 252b may electrically connect the second positive plates 250b to each other. The second negative connection pattern 252a may be arranged to face the first negative connection pattern 114a in the third direction. The second positive connection pattern 252b may be arranged to face the first positive connection pattern 114b in the third direction.

The via contacts may include first via contacts 254a electrically connecting the negative plates at different levels to each other, and second via contacts 254b electrically connecting the positive plates at different levels to each other. The first via contact 254a may be provided between the first and second negative connection patterns 114a and 252a. The second via contact 254b may be provided between the first and second positive connection pattern connection patterns 114b and 252b.

The capacitor structure described above may have a horizontal capacitance between the plates at the same level, and a vertical capacitance between upper and lower levels. The capacitor structure may have a relatively high capacitance.

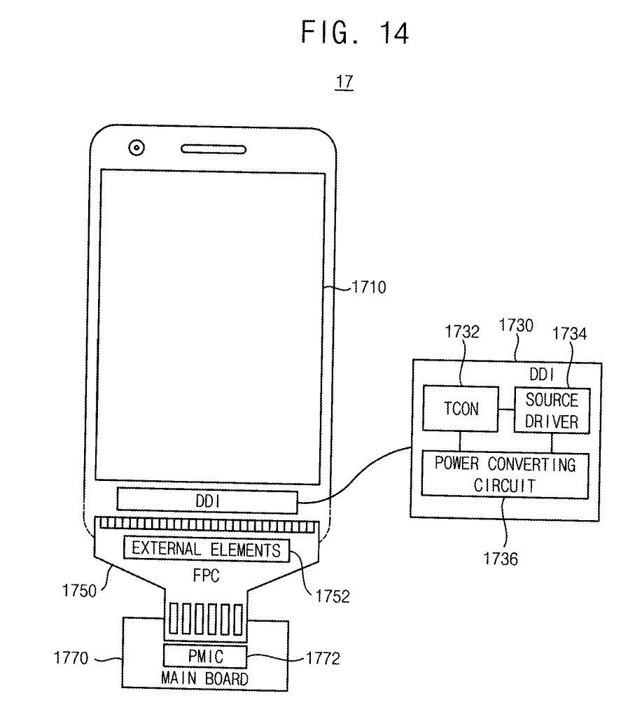

FIG. 14 is a plan view illustrating a mobile display device which includes a capacitor structure in accordance with example embodiments.

Referring to FIG. 14, the mobile display device 17 may include a display panel 1710, a display driver integrated circuit (DDI) 1730, an flexible printed circuit (FPC) 1750 and a main board 1770.

The DDI 1730 may include a source driver 1734 which supplies a source current to the display panel 1710, a power converting circuit 1736 which supplies a source voltage to the source driver 1734, and a timing controller (TCON) 1732 which supplies a clock signal to the source driver 1734 and the power converting circuit 1736. The DDI may provide a source driver including an amplification unit. A capacitor included in the amplification unit of the source driver may include at least one capacitor structure in accordance with example embodiments. As the source driver of the DDI includes the capacitor structures having a relatively high capacitance in the same planar area, the DDI may have improved characteristics and relatively high integrity. A mobile display device having the DDI may have an improved performance. The FPC 1750 may include external elements 1752 and the main board 1770 may include a power management integrated circuit (PMIC) 1772.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims.

what is claimed is:

1. A capacitor structure, comprising:
a first electrode structure including a first negative plate and a first positive plate spaced apart from each other, the first negative plate and the first positive plate being arranged alternately and repeatedly in a first direction substantially parallel to a top surface of a substrate, and the first electrode structure having a first horizontal capacitance between the first negative plate and the first positive plate; and
a second electrode structure on the first electrode structure, the second electrode structure including a second positive plate and a second negative plate spaced apart from each other, the second negative plate and the second positive plate being arranged alternately and repeatedly in the first direction, and the second electrode structure having a second horizontal capacitance between the second negative plate and the second positive plate,
wherein at least a portion of the second negative plate overlaps at least a portion of the first positive plate in a third direction substantially perpendicular to the top surface of the substrate and at least a portion of the second positive plate overlaps at least a portion of the first negative plate in the third direction, and
wherein first and second vertical capacitances are formed between the first negative plate and the second positive plate and between the first positive plate and the second negative plate, respectively.

2. The capacitor structure of claim 1, further comprising:
a dielectric layer between each of the first negative plate, the first positive plate, the second negative plate and the second positive plate in both the first and third directions,
wherein the second negative plate and the first positive plate, and the first negative plate and the second positive plate facing each other in the third direction are insulated from each other by the respective dielectric layer.

3. The capacitor structure of claim 1, wherein
the first and second negative plates are electrically connected to each other, and
the first and second positive plates are electrically connected to each other.

4. The capacitor structure of claim 3, wherein each of the first negative plate, the first positive plate, the second negative plate and the second positive plate include a first end and a second end opposite to the first end, further comprising:
a first negative connection pattern electrically connecting the first ends of the first negative plates;
a first positive connection pattern electrically connecting the second ends of the first positive plates;
a second negative connection pattern electrically connecting the first ends of the second negative plates;
a second positive connection pattern electrically connecting the second ends of the second positive plates;
first via contacts electrically connecting the first and second negative connection patterns to each other in the third direction; and
second via contacts electrically connecting the first and second positive connection patterns to each other in the third direction.

5. The capacitor structure of claim 4, wherein the first and second ends of the first positive plate and the first and second ends of the second negative plate are not aligned with each other in the third direction, and the first and second ends of the first negative plate and the first and second ends of the second positive plate are not aligned with each other in the third direction.

6. The capacitor structure of claim 1, further comprising:
first polysilicon patterns between the substrate and the first electrode structure,
wherein a third horizontal capacitance is formed between the polysilicon patterns, a third vertical capacitance is formed between each of the first polysilicon patterns and the substrate, and a fourth vertical capacitance is formed between each of the first polysilicon patterns and the first electrode structure.

7. The capacitor structure of claim 6, wherein each of the first polysilicon patterns is electrically connected to one of the first positive plate and the first negative plate.

8. The capacitor structure of claim 1, further comprising:
active regions spaced apart from each other at upper portions of the substrate,
wherein a fourth horizontal capacitance is formed between the active regions.

9. The capacitor structure of claim 8, wherein each of the active regions is electrically connected to one of the first positive plate and the first negative plate included in the first electrode structure.

10. The capacitor structure of claim 1, further comprising:
active regions spaced apart from each other on a substrate, the active regions forming a third horizontal capacitance; and
polysilicon patterns provided between the active regions of the substrate and the first electrode structure, the polysilicon patterns forming a fourth vertical capacitance.

11. The capacitor structure of claim 1, further comprising:
a third electrode structure and a fourth electrode structure sequentially stacked on the second electrode structure in the third direction,
wherein the third electrode structure has substantially the same structure as that of the first electrode structure, and the fourth electrode structure has substantially the same structure as that of the second electrode structure.

12. A capacitor structure, comprising:
a first finger electrode on a substrate, the first finger electrode including a first negative connection pattern and first negative plates, the first negative connection pattern extending in a first direction substantially parallel to a top surface of the substrate and the first negative plates, and each of the first negative plates extending from the first negative connection pattern in a second direction substantially perpendicular to the first direction;
a second finger electrode on the substrate, the second finger electrode including a first positive connection pattern and first positive plates, the first positive connection pattern extending in the first direction, and each of the first positive plates extending from the first positive connection pattern in the second direction and being inserted into a gap between the first negative plates;
a third finger electrode over the first and second finger electrodes, the third finger electrode including a second negative connection pattern and second negative plates, the second negative connection pattern extending in the first direction, and each of the second negative plates extending from the second negative connection pattern in the second direction and overlapping at least a portion of each first positive plate in a third direction substantially perpendicular to the top surface of the substrate; and
a fourth finger electrode over the first and second finger electrodes, the fourth finger electrode including a second positive connection pattern and second positive plates, the second positive connection pattern extending in the first direction, and each of the second positive plates extending from the second positive connection pattern in the second direction and overlapping at least a portion of each first negative plate in the third direction.

13. The capacitor structure of claim 12, wherein
the first and second negative connection patterns face each other in the third direction, and
the first and second positive connection patterns face each other in the third direction.

14. The capacitor structure of claim 13, further comprising:
first via contacts contacting the first and second negative connection patterns; and
second via contacts contacting the first and second positive connection patterns.

15. The capacitor structure of claim 12, further comprising:
a dielectric layer between the first negative plates included in the first finger electrode, the first positive plates included in the second finger electrode, the second negative plates included in the third finger electrode, and the second positive plates included in the fourth finger electrode, respectively.

16. The capacitor structure of claim 12, wherein
sidewalls of the second positive plates and sidewalls of the first negative plates are aligned with each other in the third direction, and
sidewalls of the second negative plates and sidewalls of the first positive plates are aligned with each other in the third direction.

17. The capacitor structure of claim 12, further comprising:
first polysilicon patterns between the substrate and the first finger electrode,
wherein a first horizontal capacitance is formed between the first polysilicon patterns, a first vertical capacitance is formed between each of the first polysilicon patterns and the substrate, and a second vertical capacitance is formed between each of the first polysilicon patterns and the first finger electrode.

18. The capacitor structure of claim 12, wherein
the first and second negative connection patterns face each other in the third direction, and the first and second positive connection patterns face each other in the third direction.

19. The capacitor structure of claim 12, further comprising:
active regions spaced apart from each other at upper portions of the substrate, the active regions having a second horizontal capacitance being formed therebetween; and
polysilicon patterns between the active regions of the substrate and the first finger electrode, each of the polysilicon patterns having a second vertical capacitance being formed therebetween and between the first finger electrode.

20. The capacitor structure of claim 12, further comprising:
fifth and sixth finger electrodes on the third and fourth finger electrodes, respectively, the fifth and sixth finger electrodes having substantially the same structures as those of the first and second finger electrodes, respectively;
seventh and eighth finger electrodes on the fifth and sixth finger electrodes, respectively, the seventh and eighth finger electrodes having substantially the same structures as those of the third and fourth finger electrodes, respectively; and
via contacts electrically connecting the first, second, third, fourth, fifth, sixth, seventh and eighth finger electrodes to each other to which a signal of the same polarity is supplied, each of the via contacts extending in the third direction.
